(19) United States
(12) Patent Application Publication
(10) Pub. No.: US 2003/0112625 A1
(43) Pub. Date: Jun. 19, 2003

(54) Lighting assembly

(76) Inventors: Wu Chen Sheng, Taichung City (TW); Chen Bin Song, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/013,360

(22) Filed: Dec. 13, 2001

(51) Int. Cl. F21V 17/00; F21S 8/08

(52) U.S. Cl. 362/225; 362/375; 362/410; 362/217

(57) ABSTRACT

A lighting assembly includes a tubular cover and a longitudinal open bottom is defined through the cover. A bottom plate is slidably connected to the open bottom of the cover and a plurality of reinforcement ribs extend from an inner side of the cover. Two groove are defined in the reinforcement ribs and two bulbs are slidably engaged with the grooves. An electrical piece is connected to a first end of the cover and electrically connected to the bulbs. An end cap is connected to a second end of the cover.

### FIELD OF THE INVENTION

The present invention relates to a lighting device comprising a cover with two bulbs slidably engaged with an inner side of the cover and a base for receiving electrical parts is connected to an end of the cover.

### BACKGROUND OF THE INVENTION

A conventional lighting assembly generally includes a socket shell with a bulb connected to the socket shell and a stand is connected to the socket shell. The bulb generates a lot of heat during use so that the user may not feel comfortable. Another type of the lighting assembly employs fluorescent bulbs and has longer operational life. The fluorescent bulbs generally exposed to the air and dust will be attached to the outside of the bulbs and affects the feature of the bulbs. Besides, a large electrical piece is necessary and connected to the fluorescent bulbs so as to provide electricity to the bulbs. The conventional lighting assembly is heavy and bulky, and cannot be portable for different use purposes.

The present invention intends to provide a lighting assembly which has a one-piece cover and the bulbs are slidably connected to the cover so as to reduce the space occupied.

### SUMMARY OF THE INVENTION

In accordance with one aspect of the present invention, there is provided a lighting assembly which comprises a tubular cover and a longitudinal open bottom is defined through the cover so that a bottom plate is connected to the open bottom of the cover. A plurality of reinforcement ribs extend from an inner side of the cover and at least one first groove is defined in the reinforcement ribs. At least one bulb is slidably engaged with the at least one first groove. An electrical piece is connected to a first end of the cover and the at least one bulb is electrically connected to the electrical piece. An end cap is connected to a second end of the cover.

The primary object of the present invention is to provide a lighting assembly that occupies less space and is easily to be portable and used in various ways.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the lighting assembly of the present invention;

FIG. 2 is an exploded view to show the lighting assembly of the present invention;

FIG. 3 is a cross sectional view to show the bulbs slidably engaged with the reinforcement ribs of the lighting assembly of the present invention;

FIG. 4 is a cross sectional view to show the beams of the bulbs are reflected by the inner side of the cover;

FIG. 5 is a perspective view to show the lighting assembly of the present invention with a stand;

FIG. 6A shows that the electrical piece is connected to a direct current electric cable;

FIG. 6B shows that the electrical piece is connected to an alternative current electric cable;

FIG. 6C shows that the base portion of the stand is connected to rechargeable pack and an adaptor;

FIGS. 7 and 8 show the lighting assembly is connected to a clamp device which attaches the lighting assembly to two types of computers;

FIGS. 9 and 10 show that hook-loop strip is used to connect the lighting device to computers; and

FIGS. 11-13 show another embodiment of the lighting device of the present invention.

### DETAILED DESCRIPTION OF THE PREFERRED EMBODIMENTS

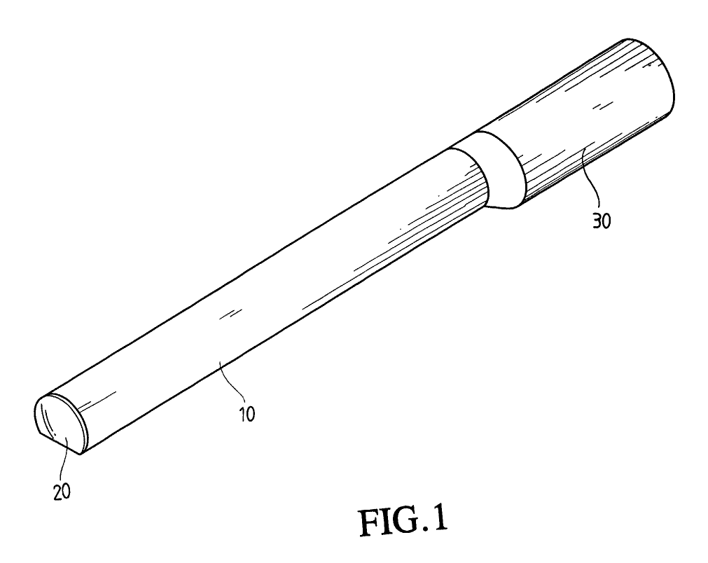

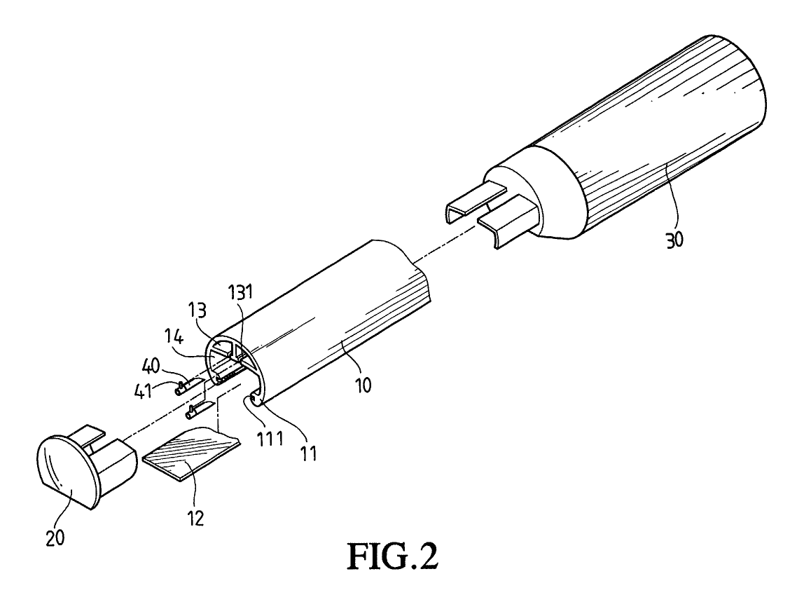

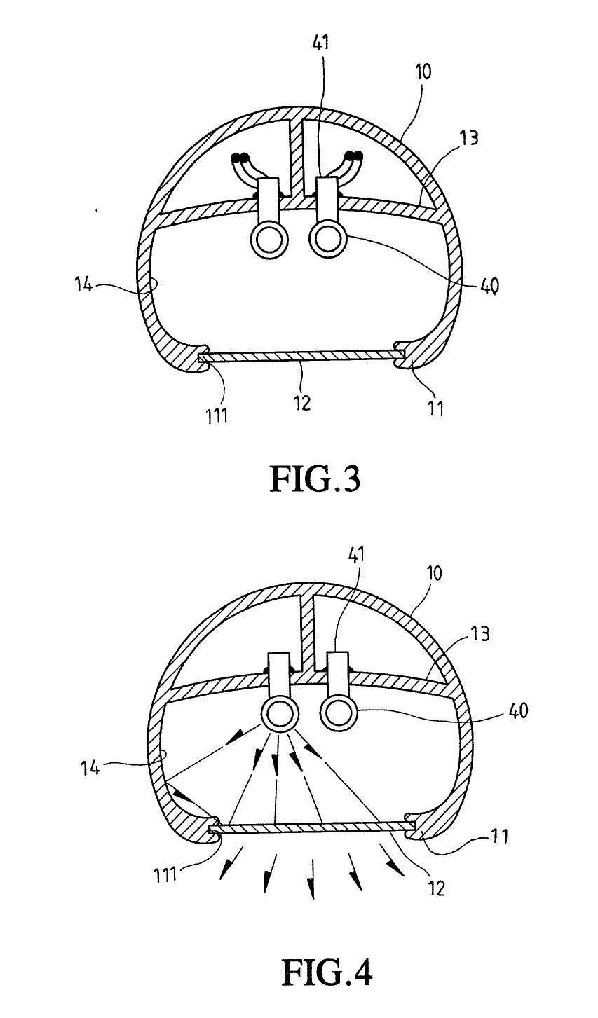

Referring to FIGS. 1 to 3, the lighting assembly of the present invention comprises a cover 10 which is a tubular one-piece member and a longitudinal open bottom is defined through the cover 10. Two lips 11 are formed along two sides defining the open bottom of the cover 10.

A plurality of reinforcement ribs 13 extend from an inner side 14 of the cover 10 and two first grooves 131 are defined in the reinforcement ribs 13. Two bulbs 40 each have an insertion 41 which is slidably engaged with respective one of the two first groove 131.

Each lip 11 has a second groove 111 defined therein and a bottom plate 12 made of PC has two sides which are slidably engaged with the two second grooves 111.

An electrical piece 30 is connected to a first end of the cover 10 and the two bulbs 40 are electrically connected to the electrical piece 30. An end cap 20 is connected to a second end of the cover 10.

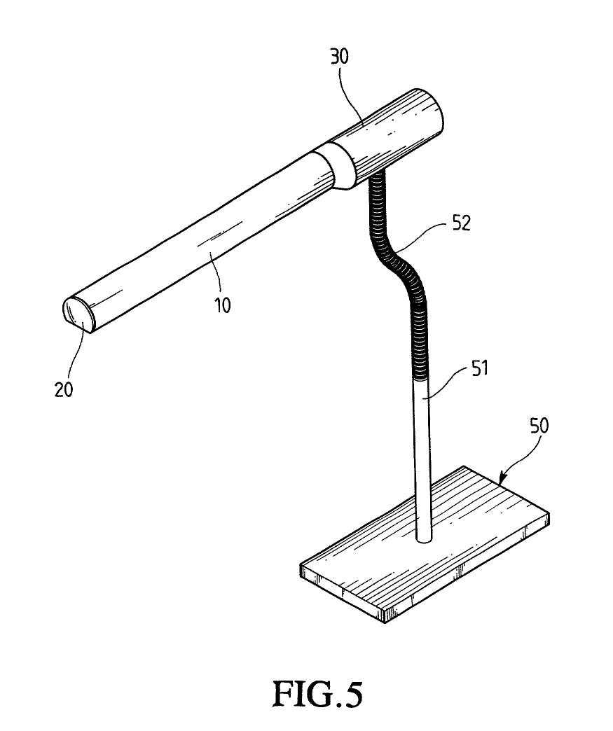

Referring to FIG. 4, the curvature of the inner side 14 of the cover 10 reflects light beams from the bulbs toward the bottom plate 12 so that the light beams can be concentrated to pass through the bottom plate 12.

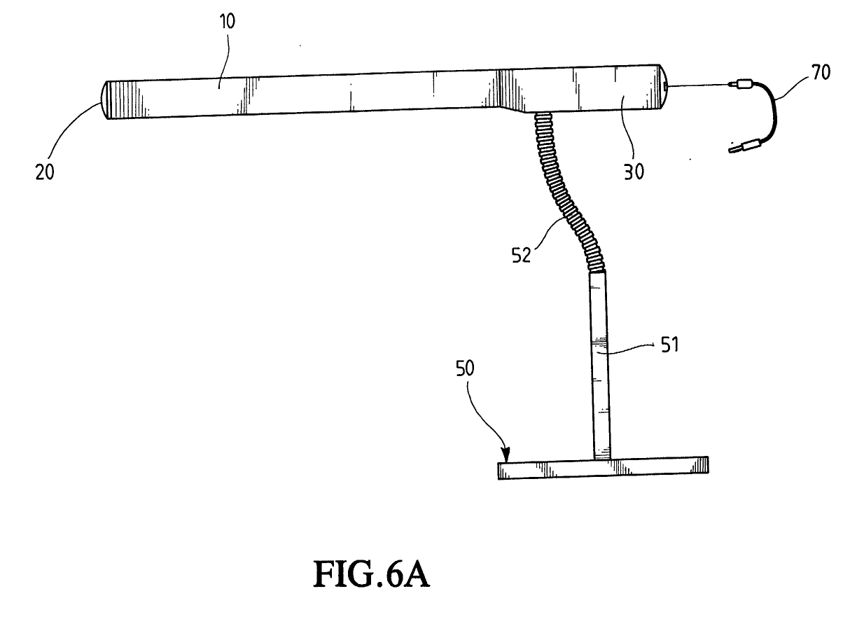

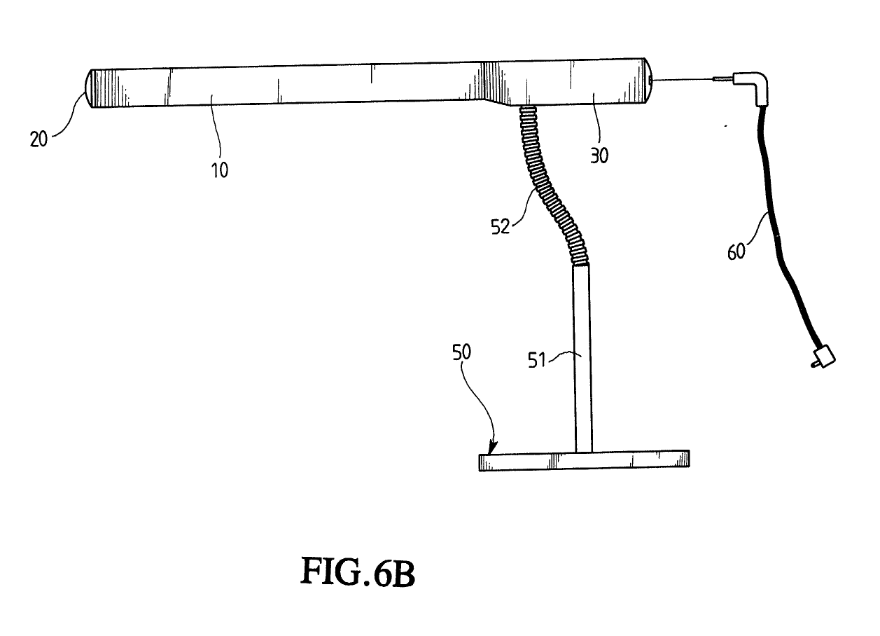

Referring to FIGS. 5, a stand comprising a base portion 50 and a connection tube which is connected to the electrical piece 30. The connection tube comprises a fixed section 51 connected to the base portion 50 and a flexible section 52 which is connected to the electrical piece 30. FIG. 6A shows a direct current electrical cable 70 is detachably connected to the electrical piece 30 and the electrical cable 70 can be connected to the cigarette lighter in vehicles. FIG. 6B shows that an alternative current electrical cable 60 is detachably connected to the electrical piece 30 so as to be connected to receptacles in houses. FIG. 6C shows that the base portion 50 of the stand is connected to rechargeable pack (battery) 53 and an electrical cable 600 is connected to the rechargeable pack 53.

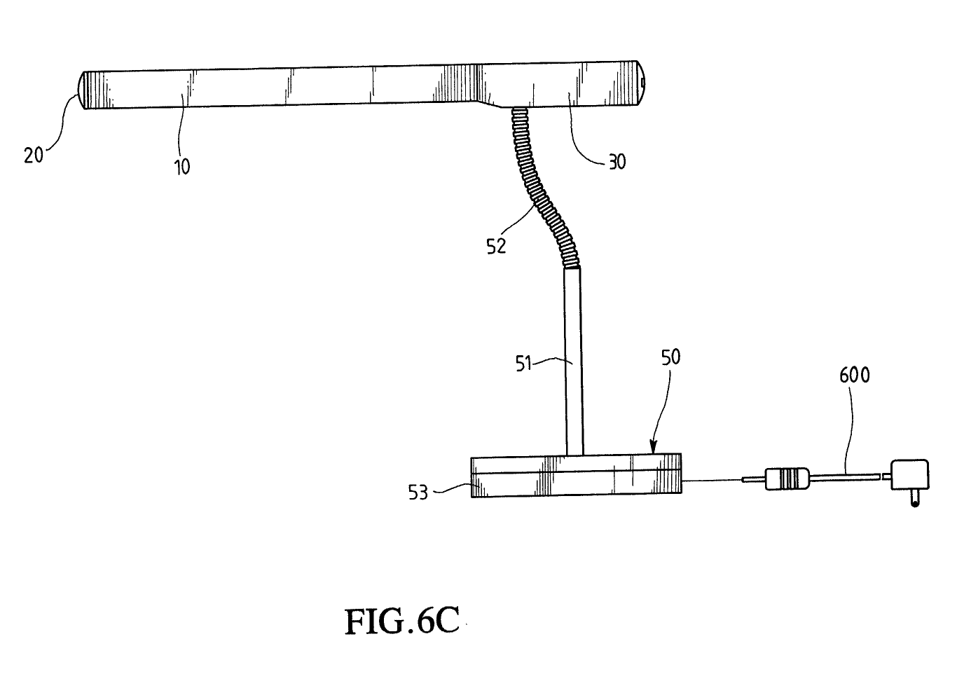

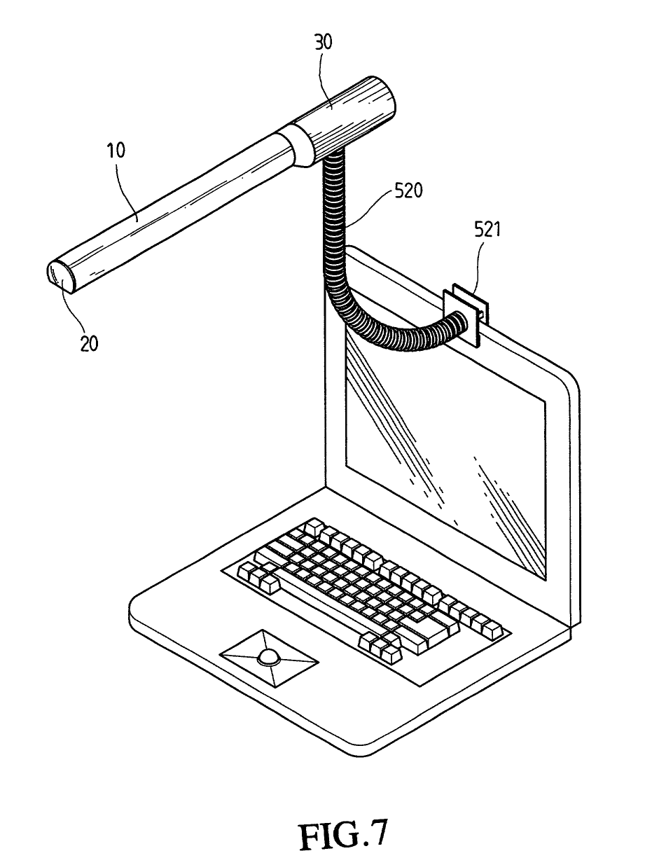

FIGS. 7 and 8 show that a clamp device 521 is connected to the connection tube 50 which is connected to the electrical piece 30. The clamp device 521 can be conveniently clamped to a proper position of a computer.

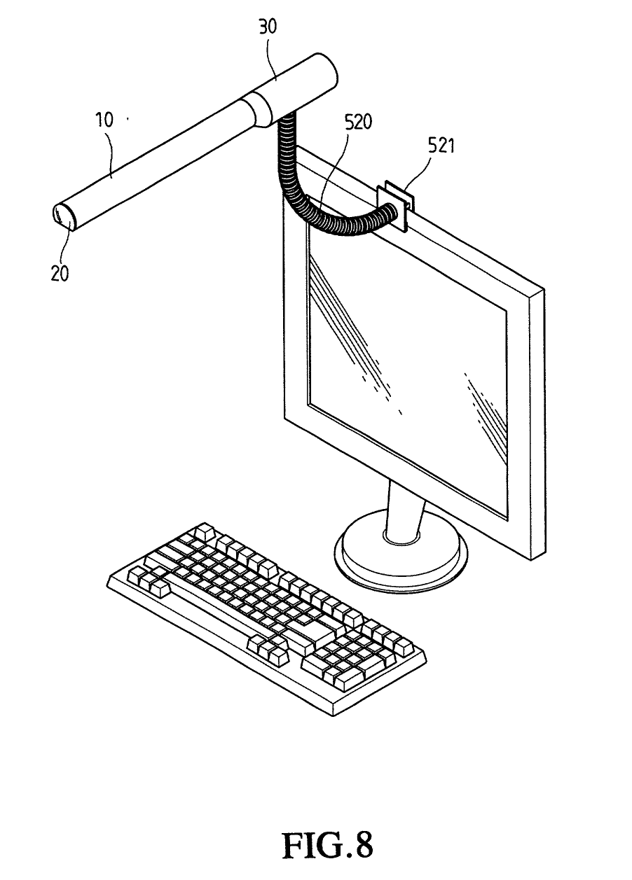

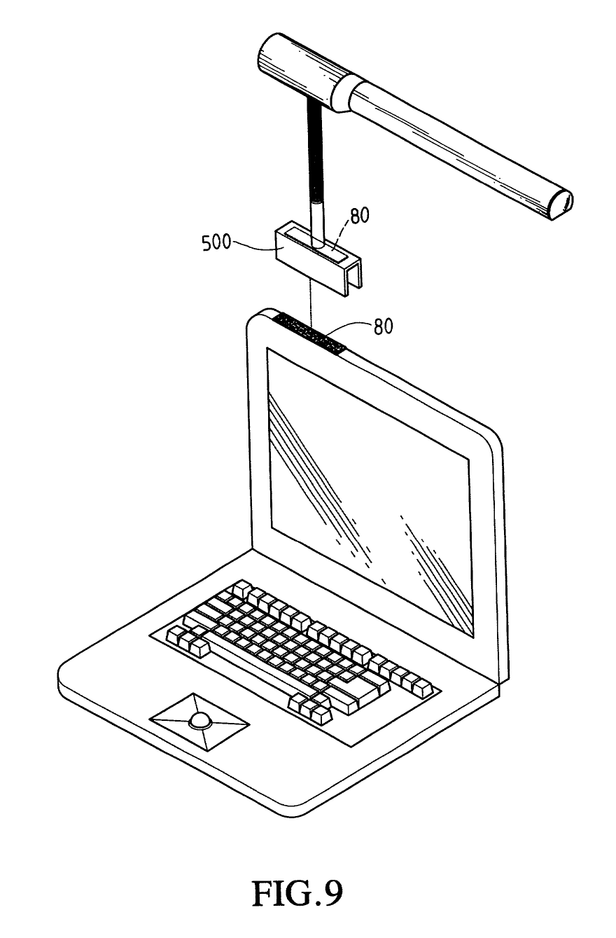

FIGS. 9 and 10 show that a position frame 500 is connected to the connection tube and two hook-loop strips 80 are used to be respectively connected to the position frame 500 and the computers.

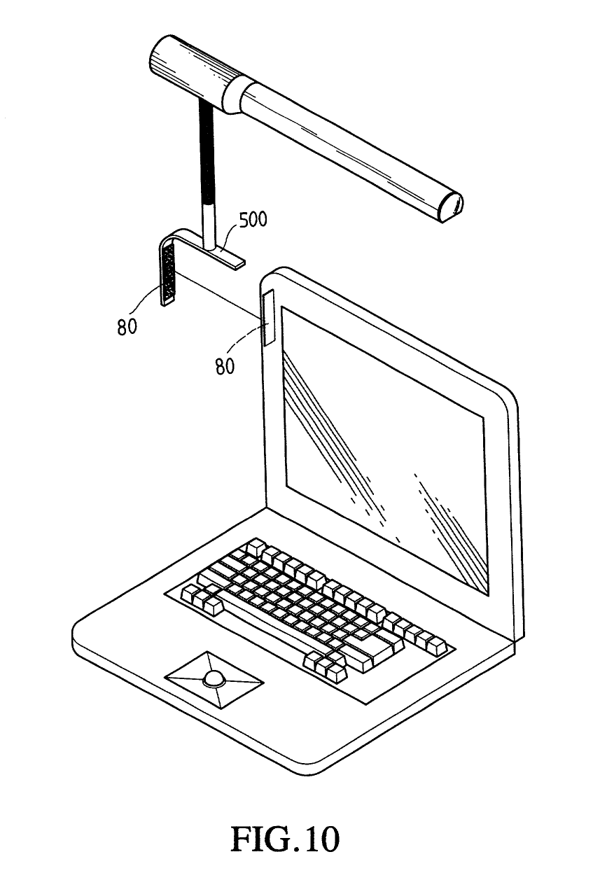

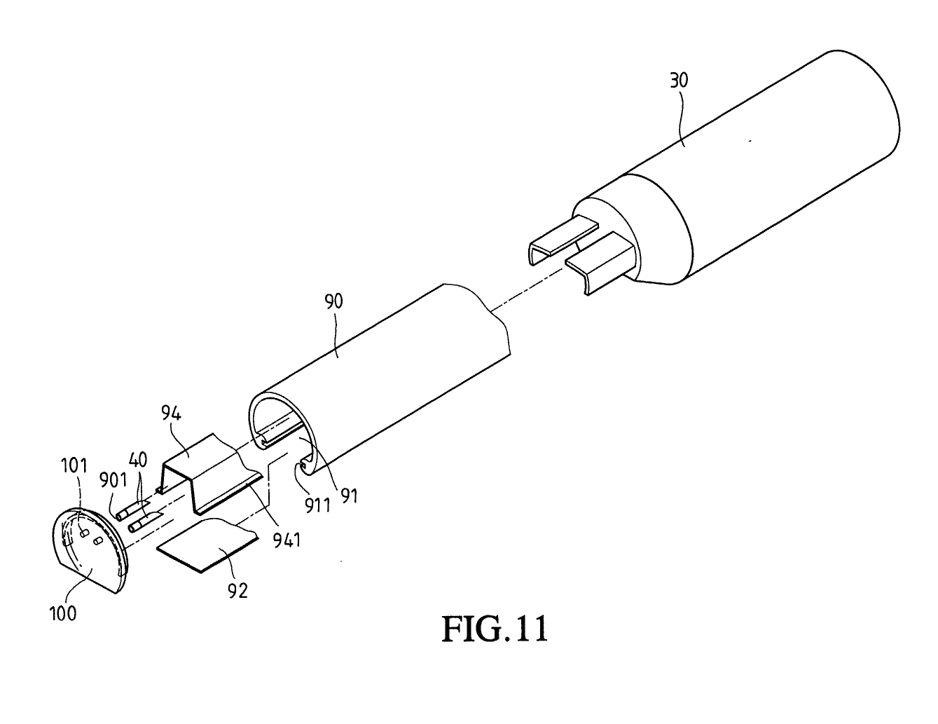

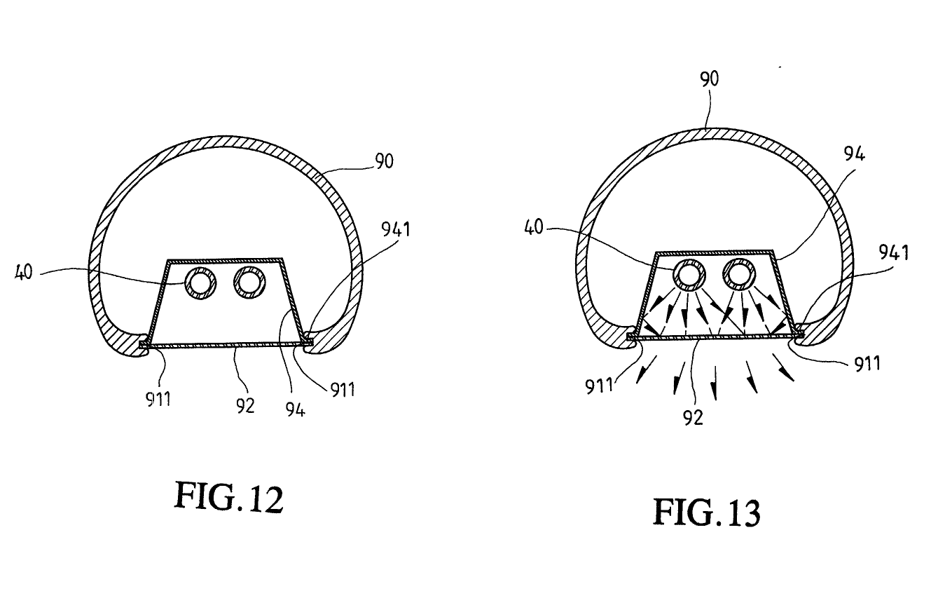

FIGS. 11-13 show another embodiment and includes a cover 90 having an open bottom 91 and two lips defining the open bottom 91 each have a groove 911 defined therein. A reflection member 94 having two flanges 941 is embraced in the cover 90 and the two flanges 941 together with two sides of a bottom plate 92 are received in the grooves 911. An end cap 100 is connected to an end of the cover 90 and the other end of the cover 90 is connected to the electrical piece 30. Two bulbs 40 are embraced by the reflection member 94 and two respective insertion tips 401 are secured in two holes 101 in the end cap 100. The light beams from the bulbs 40 are reflected by the reflection member 94 and pass through the bottom plate 12.

While we have shown and described the embodiment in accordance with the present invention, it should be clear to those skilled in the art that further embodiments may be made without departing from the scope of the present invention.

What is claimed is:

1. A lighting assembly comprising:
a cover being a tubular member and a longitudinal open bottom defined through said cover, a bottom plate connected to said open bottom of said cover, a plurality of reinforcement ribs extending from an inner side of said cover and at least one first groove defined in said reinforcement ribs, at least one bulb slidably engaged with said at least one first groove;
an electrical piece connected to a first end of said cover and said at least one bulb electrically connected to said electrical piece, and
an end cap connected to a second end of said cover.

2. The lighting assembly as claimed in claim 1, wherein two lips are formed along two sides defining said open bottom and each lip has a second groove defined therein, two sides of a said bottom plate slidably engaged with said two second grooves.

3. The lighting assembly as claimed in claim 1, wherein said curvature of said inner side of said cover reflects light beam from said bulbs toward said bottom plate.

4. The lighting assembly as claimed in claim 1 further comprising an insertion extending from said at least one bulb and said insertion engaged with said at least one first groove.

5. The lighting assembly as claimed in claim 1 further comprising a stand comprising a base portion and a connection tube which is connected to said electrical piece.

6. The lighting assembly as claimed in claim 1 further comprising an electrical cable connected to said electrical piece.

7. The lighting assembly as claimed in claim 5 further comprising a rechargeable pack connected to said base portion.

8. The lighting assembly as claimed in claim 5 further comprising a clamp device connected to said connection tube.

9. A lighting assembly comprising:
a cover being a tubular member and a longitudinal open bottom defined through said cover, a reflection member embraced by said cover and a bottom plate connected to said open bottom of said cover, and
an electrical piece connected to a first end of said cover and an end cap connected to a second end of said cover, at least one bulb electrically connected between said electrical piece and said end cap, said at least one bulb being embraced by said reflection member.

10. The lighting assembly as claimed in claim 9, wherein said reflection member has two flanges and two lips are formed along two sides defining said open bottom, each lip having a groove defined therein, two sides of a said bottom plate and said two flanges of said reflection member being slidably engaged with said two grooves of said two lips.
